(19) United States
(12) Patent Application Publication
(10) Pub. No.: US 2020/0327638 A1
(43) Pub. Date: Oct. 15, 2020

(54) CONNECTED COMPONENT DETECTION METHOD, CIRCUIT, DEVICE AND COMPUTER-READABLE STORAGE MEDIUM

(71) Applicant: SZ DJI TECHNOLOGY CO., LTD., Shenzhen (CN)

(72) Inventors: Mingming GAO, Shenzhen (CN); Tao LI, Shenzhen (CN); Kang YANG, Shenzhen (CN)

(21) Appl. No.: 16/912,008

(22) Filed: Jun. 25, 2020

Related U.S. Application Data
(63) Continuation of application No. PCT/CN2017/119971, filed on Dec. 29, 2017.

(51) Int. Cl. G06T 1/60; G06F 3/06; G06K 9/46

(52) U.S. Cl. CPC G06T 1/60; G06F 3/0604; G06F 3/0659; G06K 9/4638; G06F 3/064; G06K 9/4642; G06F 3/0673

(57) ABSTRACT

A connected component detection method includes reading an image data block from an external address block of an external storage medium, storing the read image data block in an internal address block of an internal storage medium, and performing a connected component detection using the image data block stored in the internal address block. The image data block is one of a plurality of image data blocks obtained by dividing original image data.

### CROSS-REFERENCE TO RELATED APPLICATION

This application is a continuation of International Application No. PCT/CN2017/119971, filed Dec. 29, 2017, the entire content of which is incorporated herein by reference.

### TECHNICAL FIELD

The present disclosure relates to the field of image processing, and in particular, to a connected component detection method, circuit, device, and computer-readable storage medium.

### BACKGROUND

Computer vision is a simulation of biological vision using computers and photographing devices, which, by processing collected images, obtains three-dimensional information of a corresponding scene. It is a technology about how to use the photographing device and computer to obtain data and information, and is currently widely used.

Connected component detection is a typical application of computer vision. For example, in the processing of depth image, such as Block Matching (BM), Semi-Global Block Matching (SGBM), connected component detection will be performed. However, the processing capability of the traditional connected component detection algorithms is limited by many factors, which in turn limits applications of the connected component detection algorithms.

### SUMMARY

In accordance with the disclosure, there is provided a connected component detection method including reading an image data block from an external address block of an external storage medium, storing the read image data block in an internal address block of an internal storage medium, and performing a connected component detection using the image data block stored in the internal address block. The image data block is one of a plurality of image data blocks obtained by dividing original image data.

Also in accordance with the disclosure, there is provided a detection circuit configured to read an image data block from an external address block of an external storage medium, store the read image data block in an internal address block of an internal storage medium, and perform a connected component detection using the image data block stored in the internal address block. The image data block is one of a plurality of image data blocks obtained by dividing original image data.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIGS. 1A-1D are schematic diagrams showing example application scenarios of a connected component detection method consistent with the disclosure.

FIG. 2 is a schematic diagram of an example connected component detection method consistent with the disclosure.

FIG. 3 is a schematic diagram of another example connected component detection method consistent with the disclosure.

FIG. 4 is a block diagram of an example connected component detection device consistent with the disclosure.

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

The terminology used in this disclosure is for the purpose of describing particular embodiments only and is not intended to limit the disclosure. As used in this disclosure and the appended claims, the singular forms “a” and “the” are intended to include the plural forms as well, unless the context clearly indicates otherwise. The term “and/or” as used herein refers to and includes any or all possible combinations of one or more of the associated listed items.

Although the terms first, second, third, etc. may be used to describe various information in the present disclosure, the information should not be limited to these terms. These terms are used to distinguish the same type of information from each other. For example, without deviating from the scope of the present disclosure, the first information may also be referred to as second information, and similarly, the second information may also be referred to as first information. In addition, depending on the context, the term “if” can be interpreted as “when,” or “while,” or “in response to a determination.”

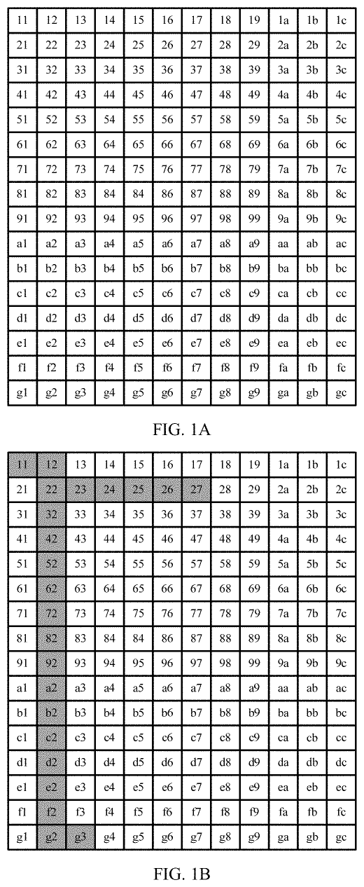

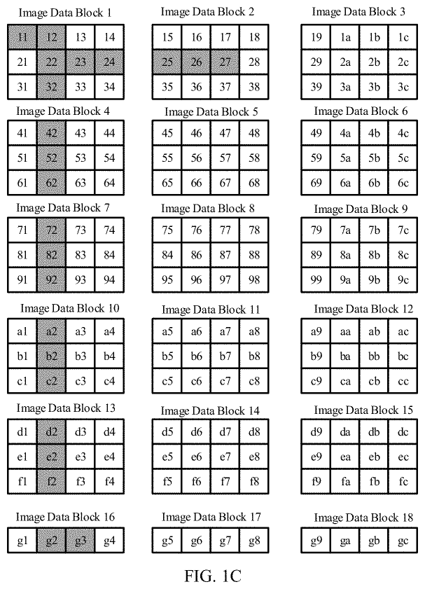

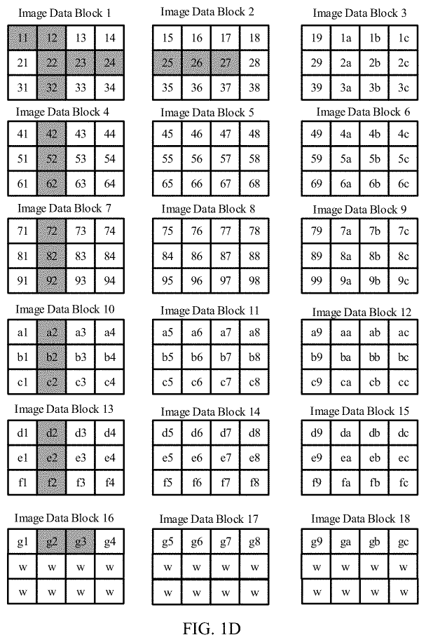

A connected component detection method for detecting connected components of an image is provided according to an embodiment of the present disclosure. FIG. 1A is an example of an image. For the description convenience, this image is referred to as original image data. The original image data can be collected or generated, which is not limited.

In the original image data, each square represents a pixel, such as pixel 11, pixel 12, pixel 13, etc. The value of each pixel can include but is not limited to pixel value, gray value, RGB (Red Green Blue) value, disparity value, etc., which is related to the original image data. For the convenience of description, the gray value is used as an example for subsequent description.

As shown in FIG. 1A, the original image data includes 16 rows of pixels and 12 columns of pixels. In actual applications, the number of rows of the original image data can be much larger than 16, for example, the original image data can have 800 rows. The number of columns of the original image data can be much larger than 12, for example, the original image data can have 1200 columns. For the convenience of description, in this embodiment, 16 rows of pixels and 12 columns of pixels are used as an example.

In the example shown in FIG. 1B, the gray pixel region (such as the region composed of pixel 11, pixel 12, and pixel 22) is a connected component. In order to detect the connected component, the following operation can be performed. One pixel A is selected and then whether there are pixels that meet the requirements among the adjacent pixels of the pixel A (such as top, bottom, left, and right) is determined. The pixel that meet the requirements refer to a valid pixel (in this disclosure, it is assumed that all pixels are valid pixels. But in actual application, there may be invalid pixels), and a pixel that has a difference between its gray value and the gray value of pixel A less than a threshold, which can be decided based on experience. If there are pixels that meet the requirements, determining whether there are pixels that meet the requirements in the adjacent pixels of these pixels are continued, and so on, until the pixels that meet the requirements cannot be detected. In this way, all pixels in the gray pixel region can be found, and these pixels form a connected component.

For example, if pixel 11 is selected, the adjacent pixels are pixel 12 and pixel 21. After the determination (such as determination of valid pixels, determination based on threshold value, and etc.), pixel 12 is determined to be a pixel that meets the requirements, and pixel 21 is determined to be not a pixel that meets the requirements. Therefore, pixel 12 is selected and the adjacent pixels are pixel 11, pixel 13 and pixel 22. Since pixel 11 has undergone determination, no determination is needed for pixel 11 at this time. After the determination, pixel 13 is not a pixel that meets the requirements and pixel 22 is a pixel that meets the requirements.

Therefore, pixel 22 is selected and the adjacent pixels are pixel 12, pixel 21, pixel 23 and pixel 32. Since pixel 12 has undergone determination, no determination is needed for pixel 12 at this time. After the determination, pixel 21 is not a pixel that meets the requirements. Both pixel 23 and pixel 32 are pixels that meet the requirements.

Therefore, pixel 23 and pixel 32 are selected, and so on. All pixels in the gray pixel region are pixels that meet the requirements. Further, the area of the gray pixel region can also be calculated. If the area of the region is smaller than a threshold, the gray pixel region is not considered as a connected component. If the area of the region is larger than a threshold, the gray pixel region is considered as a connected component.

In one embodiment, the original image data can be stored in a double rate synchronous dynamic random-access memory (DDR SDRAM). The original image data can also be stored in other storage media, which is not limited herein. In the following description, the original image is stored in the DDR as an example.

When the original image data is stored in the DDR, the original image data is stored in rows. For example, the gray values of pixel 11 to pixel 1c are sequentially stored. After the gray value of pixel 1c, the gray values of pixel 21 to pixel 2c are sequentially stored. After the gray value of pixel 2c, the gray values of pixel 31 to pixel 3c are sequentially stored, and so on. At last, the gray value of the pixel gc is stored.

In order to realize the connected component detection, the data in the DDR (such as the gray value of each pixel in the original image data) can be read into an on-chip cache, and the on-chip cached data can be used to detect the connected component. For example, if a central processing unit (CPU) implements the connected component detection, the CPU reads the data in the DDR to the on-chip cache of the CPU and uses the on-chip cached data to perform the connected component detection. If a detection circuit implements the connected component detection, the detection circuit reads the data in the DDR to the on-chip cache of the detection circuit and uses the on-chip cached data to perform the connected component detection.

However, the traditional connected component detection method requires a large amount of storage resource of the on-chip cache. Due to the limited storage resources of the on-chip cache, the processing capability of the traditional connected component detection method is limited by many factors, which in turn limits applications of the connected component detection method.

For example, the storage resources of the on-chip cache can only store the gray values of 12 pixels. Therefore, when the CPU or the detection circuit reads the data for the first time, the gray values of pixel 11 to pixel 1c in DDR are read and stored in its own on-chip cache.

When pixel 11 is selected, pixel 12 and pixel 21 are adjacent pixels. Since there is the gray value of pixel 12 in the on-chip cache, the gray value of pixel 12 is used to determine that pixel 12 is a pixel that meets the requirements. Since there is not the gray value of pixel 21 in the on-chip cache, the on-chip cached data is deleted, and the gray values of pixel 21 to pixel 2c in DDR are read and stored in its own on-chip cache. In this way, since there is the gray value of pixel 21 in the on-chip cache, the gray value of pixel 21 is used to determine that pixel 21 is not a pixel that meets the requirements. Accordingly, the above operations are performed for each pixel selected.

In summary, due to the limited storage resources of the on-chip cache, the CPU or the detection circuit needs to frequently read data from the DDR, which occupies a large amount of the DDR bandwidth, and makes the performance of the connected component detection very low.

In order to reduce the number of readings, the storage resources of the on-chip cache can be increased. For example, in order to detect the connected component of the gray pixel region, the gray values of all pixels may be read from the DDR. In this way, the storage resources need to store the gray values of 16*12 pixels, which takes up a lot of storage resources. Obviously, when the original image data has more rows and more columns, more storage resources are required.

As shown in FIG. 1B, in order to detect the connected component of the gray pixel region, after pixel 12 is selected, determination is needed for pixel 13. Since pixel 13 is not a pixel that meets the requirements, the gray values of pixel 14 to pixel 1c has no meanings, that is, the gray values of pixel 14 to pixel 1c are not needed. Similarly, there is no need to use the gray values of pixel 29 to pixel 2c, the gray values of pixel 34 to pixel 3c, the gray values of pixel 44 to pixel 4c, and so on. Obviously, there are a large number of pixels in the original image data that do not need to undergo determination.

In response to the above findings, in the embodiments of the present disclosure, when the original image data is stored in the DDR, the original image data is not stored in rows, but in blocks of image data. For example, the size of the image data block is 3 rows*4 columns, and the original image data can be divided into 18 image data blocks. As shown in FIG. 1C, the original image data is divided into image data block 1 to image data block 18. Based on this, image data block 1 to image data block 18 can be sequentially stored in the DDR. For example, when storing image data block 1, the gray values of pixel 11 to pixel 14 are sequentially stored. After the gray values of pixel 14, instead of storing the gray value of pixel 15, the gray values of pixel 21 to pixel 24 are sequentially stored. After the gray value of pixel 24, the gray values of pixel 31 to pixel 34 are sequentially stored. In this way, the storage of image data block 1 can be completed. Then, image data block 2 is stored, that is, after the gray value of pixel 34, the gray values of pixel 15 to pixel 18 are sequentially stored, and so on. Finally, the storage of image data block 1 to image data block 18 is completed, and image data block 18 is stored at last.

Based on the above storage method, in the embodiments of the present disclosure, when the data in the DDR is being read to the on-chip cache, the data of the DDR image data block (that is, the gray value of each pixel) can be read, and the read data is stored in on-chip cache. For example, as shown in FIG. 1C, in order to detect the connected component of the gray pixel region, it is only needed to read the data of image data block 1, the data of image data block 2, the data of image data block 4, the data of image data block 7, the data of image data block 10, the data of image data block 13, and the data of image data block 16, without reading the data of all the image data blocks.

In this way, if the storage resources of the on-chip cache are limited, data will not be read from the DDR frequently. Therefore, the number of data reading is reduced, and a large amount of DDR bandwidth is saved. As a result, the performance of the connected component detection is improved. Moreover, reducing the number of reading can also reduce the occupied storage resources of the on-chip cache. For example, the storage resources of the on-chip cache only need to store the gray values of 4*3*6+4 pixels, which can significantly reduce the occupied storage resources.

In summary, in the embodiments of the present disclosure, after the DDR stores data in the form of image data blocks, the CPU or the detection circuit can read more rows and columns of data in one reading, which reduces the number of accesses to DDR by row, such as reading 3 rows*4 columns of data at a time. When the numbers of rows and columns of the image data block are different values, such as 8 rows*16 columns, the data of 8 rows*16 columns can also be read at a time. That is, 8 rows*16 columns of data can be read with one access to DDR.

A connected component detection method is provided according to the present disclosure. The connected component detection method can be applied to a CPU (implemented in software) or a detection circuit (implemented in hardware), which is not limited. For the convenience of description, in the following embodiments, a detection circuit is taken as an example.

The detection circuit may include but is not limited to a field programmable gate array (FPGA) chip or an application specific integrated circuit (ASIC) chip. It can also be other types of chips, which is not limited.

In one embodiment, since the connected component detection method is implemented in the detection circuit, the storage medium of the detection circuit may be referred to as an internal storage medium, and the storage medium storing the original image data may be referred to as an external storage medium. This external storage medium is not a storage medium of the detection circuit. The internal storage medium may include but is not limited to the on-chip cache of the detection circuit, and the external storage medium may include but is not limited to the dynamic random-access memory, such as the DDR mentioned above, which may also be referred to as an off-chip DDR of the detection circuit.

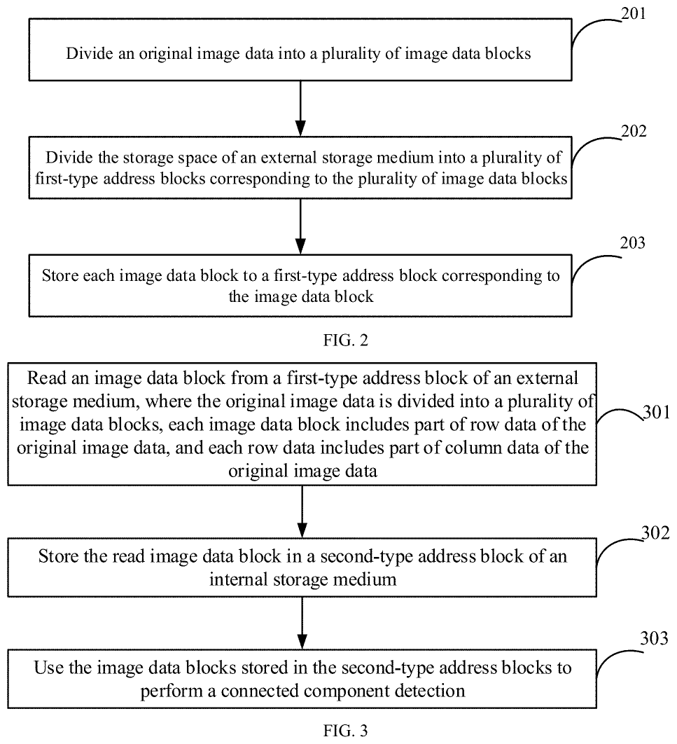

In order to store the image data blocks of the original image data in an external storage medium (such as DDR), a connected component detection method is provided according to the embodiments of the present disclosure. As shown in FIG. 2, at 201, the original image data is divided into a plurality of image data blocks.

Dividing the original image data into a plurality of image data blocks includes dividing the original image data into a plurality of image data blocks according to the M*N (that is, M rows*N columns) division strategy. For each image data block, at most M rows of original image data can be included, and at most N columns of original image data can be included. Moreover, M is an integer greater than or equal to 1 an N is an integer greater than or equal to 1. M is less than the total number of rows of the original image data and N is less than the total number of columns of the original image data.

For example, the values of both M and N can be decided according to experience. There is no restriction on this as long as M is greater than or equal to 1 and less than the total number of rows of the original image data, and N is greater than or equal to 1 and less than the total number of columns of the original image data. For example, when M is 3 and N is 4, each image data block includes at most 3 rows of original image data and at most 4 columns of original image data. FIG. 1C shows an example of an image data block with M being 3 and N being 4. For another example, when M is 8 and N is 6, each image data block includes at most 8 rows of original image data and at most 6 columns of original image data.

At 202, the storage space of the external storage medium is divided into a plurality of first-type address blocks corresponding to the plurality of image data blocks (for the convenience of distinction, each address block in the external storage medium may be referred to as a first-type address block or an external address block). That is, each image data block corresponds to a first-type address block of the external storage medium.

As shown in FIG. 1C, after the original image data is divided into 18 image data blocks, the storage space of the external storage medium can be divided into 18 first-type address blocks. First-type address block 1 is used to store the data of image data block 1, that is, first-type address block 1 sequentially stores the gray values of pixel 11 to pixel 14, the gray values of pixel 21 to pixel 24, and the gray values of pixel 31 to pixel 34. In addition, first-type address block 2 is used to store the data of image data block 2, first-type address block 3 is used to store the data of image data block 3, and so on. No further description will be given to other first-type address blocks.

Since the maximal size of the image data block can be M*N, the size of each first-type address block is M*N, that is, the gray values of M*N pixels can be stored. As shown in FIG. 1C, the sizes of first-type address block 1 to first-type address block 18 may be 3*4. For first-type address block 16 to first-type address block 18, the sizes are also 3*4, although these first-type address blocks only store 1*4 gray values.

At 203, each image data block is stored to the first-type address block corresponding to the image data block.

For example, the data of image data block 1 may be stored in first-type address block 1, the data of image data block 2 may be stored in first-type address block 2, and so on. For the specific storage method, the above steps can be referred to.

In one embodiment, since the image data blocks are obtained in the detection circuit, the data is read from the first-type address block of the external storage medium and is stored to the internal storage medium. The storage space of the internal storage medium can be divided into a plurality of second-type address blocks (for the convenience of distinction, each address block in the internal storage medium can be referred to as a second-type address block or an internal address block). Because the maximal size of the image data block is M*N, the size of the second-type address block is M*N, that is, the gray values of M*N pixels can be stored.

The number of the second-type address blocks is at least one, which is related to the storage resource of the internal storage medium (such as on-chip cache). Since the storage resource of the internal storage medium is limited, the number of the second-type address block in the internal storage medium is usually less than the number of the first-type address blocks in the external storage medium.

For example, it is assumed that the storage resources of the internal storage medium can only store gray values of 48 pixels, and the size of each second-type address block is 3*4, that is, each second-type address block is used to store gray values of 12 pixels. Based on this, the storage space of the internal storage medium can be divided into 4 second-type address blocks, and these 4 second-type address blocks can be respectively second-type address block 1 to second-type address block 4.

In order to store the data in the first-type address block of the external storage medium to the second-type address block of the internal storage medium, each first-type address block can be mapped to a second-type address block. That is each first-type address block has a corresponding second-type address block, so that the data of the first-type address block can be stored in the second-type address block. For example, first-type address block 1 can be mapped to second-type address block 1, so that the data of first-type address block 1 can be stored to second-type address block 1.

When mapping the first-type address block to the second-type address block, since the number of the second-type address blocks is smaller than the number of the first-type address blocks, each second-type address block may correspond to one or more first-type address blocks, but each first-type address block may correspond to only one second-type address block.

After mapping the first-type address block to the second-type address block, a mapping relationship between the first-type address block and the second-type address block is obtained and the mapping relationship between the first-type address block and the second-type address block is recorded in a mapping table. The mapping relationship between the first-type address block and the second-type address block can be configured based on experience, which is not limited here. After obtaining the mapping relationship, the mapping relationship can be recorded in the mapping table. Table 1 shows an example of the mapping table, and the content of the mapping table is not limited.

TABLE 1

| First-Type Address Block | Second-Type Address Block |
|---|---|
| 1 [symbol] 5 [symbol] 9 [symbol] 13 [symbol] 17 | 1 |
| 2 [symbol] 6 [symbol] 10 [symbol] 14 [symbol] 18 | 2 |
| 3 [symbol] 7 [symbol] 11 [symbol] 15 | 3 |
| 4 [symbol] 8 [symbol] 12 [symbol] 16 | 4 |

FIG. 3 is a flowchart of another example connected component detection method consistent with the disclosure.

At 301, an image data block from a first-type address block of an external storage medium is read. The original image data is divided into a plurality of image data blocks and each image data block includes part of row data of the original image data. Each row data includes part of column data of the original image data.

The first-type address block is an arbitrary address block of an external storage medium (such as DDR).

In one embodiment, reading the image data block from the first-type address block of the external storage medium includes reading data of M*N pixels sequentially from the starting address of the first-type address blocks of the external storage medium, and forming image data blocks out of the read data. M and N are both integers greater than or equal to 1. M is the number of rows of the image data block, and N is the number of columns of the image data block. Moreover, M is less than the total number of rows of the original image data, and N is less than the total number of columns of the original image data.

At 302, the read image data block is stored in a second-type address block of an internal storage medium.

The second-type address block is an arbitrary address block of the internal storage medium (such as an on-chip cache).

Storing the read image data block in the second-type address block of the internal storage medium includes determining a second-type address block corresponding to a first-type address block (i.e., a first-type address block where the image data block is located) based on a mapping table and storing the read image data block to the second-type address block corresponding to the first-type address block. The mapping table is used to record a mapping relationship between the first-type address block and the second-type address block.

In one embodiment, storing the read image data block to the second-type address block corresponding to the first-type address block may include if the second-type address block corresponding to the first-type address block has already stored an image data block, deleting the image data block stored in the second-type address block, and storing the read image data block in the second-type address block. If the second-type address block corresponding to the first-type address block does not store an image data block, the read image data block can be directly stored in the second-type address block.

At 303, the image data blocks stored in the second-type address blocks are used to perform a connected component detection.

After using the image data block stored in the second-type address block to perform the connected component detection, when performing the connected component detection on a pixel in the image data block stored in the second-type address block, an image data block associated with the pixel can be determined, and the image data block can be read from the first-type address block that is used to store the image data block. Then the read image data block is stored into the second-type address block of the internal storage medium and the connected component detection is continued with using the image data block stored in the second-type address block.

In one embodiment, determining the image data block associated with the pixel may include, but is not limited to, the following ways. If the last column of data of the current image data block is detected, the image data block including the column of data next to the last column of data is determined as the image data block associated with the pixel. And/or, if the last row of data of the current image data block is detected, the image data block including the row of data next to the last row of data is determined as the image data block associated with the pixel.

In one embodiment, reading the image data block from the first-type address block used to store the image data block may include, but is not limited to, the following ways. After the detection of the current image data block that is used for the connected component detection of pixels is completed, the image data block is read from the first-type address block used to store the image data block. Or, after the image data block associated with the pixel is determined, the image data block may be directly read from the first-type address block used to store the image data block.

In one embodiment, after the original image data is divided into a plurality of image data blocks according to the division strategy of M*N (that is, M rows*N columns), if the bottom image data block and/or the rightmost image data block are beyond the boundary (that is, the boundary of the original image data), there may be some invalid data. Based on this, in the process of the connected component detection, the invalid data is determined according to the size of the image and does not participate in the connected component detection. Specifically, during the comparison, the current comparison position is recorded, and when the position is compared with the size of the image, the image boundary cannot be exceeded.

For example, as shown in FIGS. 1A and 1B, the original image data includes 16 rows of pixels and 12 columns of pixels, and the original image data can be divided into 18 image data blocks as shown in FIG. 1C. Since each image data block is 3 rows*4 columns, image data block 16 to image data block 18 should have two more rows of data. As shown in FIG. 1D, these two rows of data are denoted by w, that is, all w are invalid data. These invalid data can be identified by using the size of the original image data.

The above processes of 301 to 303 will be described below with the embodiments shown in FIG. 1C.

As shown in FIG. 1C, it is assumed that the gray pixel region (such as the region composed of pixel 11, pixel 12, and pixel 22) is a connected component. In order to detect the connected component, the following operations can be performed.

Image data block 1 is read from first-type address block 1 of the external storage medium. Image data block 1 includes 3 rows of original image data, and each row of data includes 4 columns of original image data. Specifically, the data of 3*4 pixels can be sequentially read from the starting address of first-type address block 1, and the data can be composed into image data block 1. Since first-type address block 1 sequentially stores the gray values of pixel 11 to pixel 14, the gray values of pixel 21 to pixel 24, and the gray values of pixel 31 to pixel 34, the gray values of the above pixels can be read when starting to read the data of 3*4 pixels from the starting address of first-type address block 1, and then these gray values are composed into image data block 1.

By looking up the table 1, it is determined that first-type address block 1 corresponds to second-type address block 1, so image data block 1 can be stored in second-type address block 1. Since second-type address block 1 does not currently store an image data block, image data block 1 can be directly stored in second-type address block 1.

Further, since the size of image data block 1 is 3 rows*4 columns, and the size of second-type address block 1 is also 3 rows*4 columns, second-type address block 1 can store image data block 1.

Then, image data block 1 stored in second-type address block 1 is used to perform the connected component detection. Specifically, pixel 11 is selected, and the adjacent pixels are pixel 12 and pixel 21. Since image data block 1 has pixel 12 and pixel 21, no new image data block is read from the external storage medium.

After the determination (such as the determination of valid pixels, the determination of the threshold value, and etc.), pixel 12 is a pixel that meets the requirements, and pixel 21 is not a pixel that meets the requirements. Therefore, pixel 12 is selected and the adjacent pixels are pixel 11, pixel 13 and pixel 22. Since pixel 11 has undergone determination, no determination is needed for pixel 11 at this time. After the determination, pixel 13 is not a pixel that meets the requirements and pixel 22 is a pixel that meets the requirements.

Therefore, pixel 22 is selected and the adjacent pixels are pixel 12, pixel 21, pixel 23 and pixel 32. Since pixel 12 and pixel 21 have undergone determination, no determination is needed for pixel 12 and pixel 21 at this time. After the determination, both pixel 23 and pixel 32 are pixels that meet the requirements. Then pixel 23 and pixel 32 are selected. In this example, pixel 23 is first selected and then pixel 32 is selected.

Pixel 23 is selected, and the adjacent pixels are pixel 13, pixel 22, pixel 24 and pixel 33. Since pixel 13 and pixel 22 have undergone determination, no determination is needed for pixel 13 and pixel 22 at this time. After the determination, pixel 24 is a pixel that meets the requirements, and pixel 33 is not a pixel that meets the requirements. Pixel 24 is selected, and the adjacent pixels are pixel 14, pixel 23, pixel 25 and pixel 34. Since pixel 24 is the last column of data of the current image data block 1, image data block 2 including the column of data next to the last column of data is determined as the image data block associated with pixel 11.

In one embodiment, after determining image data block 2 associated with pixel 11, image data block 2 can be directly read from first-type address block 2 of the external storage medium. In another embodiment, image data block 2 can be read from first-type address block 2 of the external storage medium after completing the detection of the current image data block 1. There is no restriction on this process. In the following embodiments, image data block 2 is directly read from first-type address block 2, and then second-type address block 2 corresponding to first-type address block 2 is determined by looking up the table 1. Then image data block 2 is stored into second-type address block 2.

For pixel 24, since the adjacent pixels (pixel 14, pixel 23, pixel 25, and pixel 34) are already stored in second-type address block 1 and second-type address block 2 of the internal storage medium, the pixels adjacent to pixel 24 are determined. Since pixel 23 has undergone determination, no determination is needed for pixel 23 at this time. After the determination, pixel 25 is a pixel that meets the requirements, and pixel 14 and pixel 34 are not pixels that meet the requirements. Further, after selecting pixel 25, it is determined that pixel 26 is a pixel that meets the requirements. After selecting pixel 26, it is determined that pixel 27 is a pixel that meets the requirements.

Pixel 32 is selected. Since pixel 32 is the last row of data in the current image data block 1, image data block 4 where the next row of data is located is determined as the image data block associated with pixel 11. Then, image data block 4 is read from first-type address block 4, and second-type address block 4 corresponding to first-type address block 4 is determined by looking up the table 1. Then image data block 4 is stored into second-type address block 4.

For pixel 32, since pixel 22 has already undergone determination, no determination is needed for pixel 22 at this time. After the determination, pixel 42 is a pixel that meets the requirements. Then, after selecting pixel 42, it is determined that pixel 52 is a pixel that meets the requirements. After selecting pixel 52, it is determined that pixel 62 is a pixel that meets the requirements.

After selecting pixel 62, the associated image data block 7 is determined and image data block 7 is read from first-type address block 7. By looking up the table 1, second-type address block 3 corresponding to first-type address block 7 is determined, and image data block 7 is stored in second-type address block 3. For pixel 62, after the determination, pixel 72 is a pixel that meets the requirements. Then, after selecting pixel 72, it is determined that pixel 82 is a pixel that meets the requirements. After selecting pixel 82, it is determined that pixel 92 is a pixel that meets the requirements.

After pixel 92 is selected, the associated image data block 10 is determined and image data block 10 is read from first-type address block 10. Through looking up the table 1, second-type address block 2 corresponding to first-type address block 10 is determined. Image data block 2 stored in second-type address block 2 is deleted, and image data block 10 is stored in second-type address block 2. For pixel 92, after the determination, the pixel a2 is a pixel that meets the requirements. Similarly, pixel b2, pixel c2, pixel d2, pixel e2, pixel f2, pixel g2, and pixel g3 are also pixels that meet the requirements, and the determination process is not repeated here.

In summary, all pixels in the gray pixel region are pixels that meet the requirements. Then, based on the area of the gray pixel region, it is determined that the gray pixel region is a connected component.

In the above embodiments, using the image data block stored in the second-type address block to perform the connected component detection includes when performing the connected component detection on a first pixel of the image data block stored in the second-type address block, selecting a second pixel associated with the first pixel from the image data block and performing the connected component detection based on the state information of the second pixel if there is state information of the second pixel. The state information can be used to indicate whether a connected component detection has been performed on the second pixel, and the state information can indicate that a connected component detection has not been performed, or a connected component detection has been performed and the detection result is that the pixel is not connected, or a connected component detection has been performed and the detection result is that the pixel is connected.

Further, performing the connected component detection according to the state information of the second pixel includes if the state information is that the connected component detection has not been performed, detecting whether the second pixel and the first pixel belong to the same connected component, and updating the state information of the second pixel according to the detection result. If the state information is that the connected component detection has been performed and the detection result is that the pixel is not connected, it can be determined that the second pixel and the first pixel do not belong to the same connected component. If the state information is that the connected component detection has been detected and the detection result is that the pixel is connected, it can be determined that the second pixel and the first pixel belong to the same connected component. That is, the connected component detection has been performed on the second pixel, and there is no need to repeat the connected component detection.

In one embodiment, after selecting the second pixel associated with the first pixel from the image data block, if there is no state information of the second pixel, it can be detected whether the second pixel and the first pixel belong to the same connected component, and the state information of the second pixel can be updated according to the detection result.

In one embodiment, when reading the image data block from the first-type address block of the external storage medium, the state information corresponding to each pixel in the image data block may also be read from the external storage medium, and the read state information is stored in the register of the internal storage medium. Based on this, the detection circuit can obtain the state information of the second pixel from the register of the internal storage medium.

Further, after storing the read state information in the register of the internal storage medium, and after using the pixel of the image data block to perform the connected component detection, the state information corresponding to the pixel can also be determined and stored in the register to update the state information corresponding to the pixel. Then, all the state information in the register can be updated to the external storage medium, such as the register of the external storage medium.

The related process of the above state information will be described below with the embodiments shown in FIG. 1C.

In order to reduce the number of repeated calculations, state information can be recorded for each pixel, such as using 2 bits to represent the state information of the pixel. For example, 00 means that the state information of the pixel is that the connected component detection is not performed, 01 means that the state information of the pixel is that the connected component detection is performed and the detection result is that the pixel is not connected, and 10 means that the state information of the pixel is that the connected component detection is performed and the detection result is that the pixel is connected.

In order to record the state information of pixels, the external storage medium may include a register and the register is used to record the state information of all pixels. For example, when the number of pixels is 16*12, the register includes 16*12*2 bits, and these bits sequentially record the state information of each pixel in each image data block. For example, the first and second bits are used to record the state information of pixel 11, the third and fourth bits are used to record the state information of pixel 12, the fifth and sixth bits are used to record the state information of pixel 13, the seventh and eighth bits are used to record the state information of pixel 14, the ninth and tenth bits are used to record the state information of pixel 21 (instead of recording the state information of pixel 15), and so on.

In order to record the state information of pixels, the internal storage medium may also include a register, and the register is used to record the state information of all pixels and may also be used to record the state information of some pixels. Considering the limited storage resources of the internal storage medium, this register is used to record the state information of some pixels. For example, the internal storage medium includes 4 second-type address blocks and each second-type address block has a size of 3*4. Therefore, the register includes 3*4*4*2 bits, and these bits sequentially record the state information of each pixel in the image data block of each second-type address block. For example, the first and second bits are used to record the state information of the first pixel of second-type address block 1, the third and fourth bits are used to record the state information of the second pixel of second-type address block 1, and so on. The 25th and 26th bits are used to record the state information of the first pixel of second-type address block 2, and so on, which is not repeated here.

In the initial state, all the bits of the register of the external storage medium are 0, indicating that the state information of all pixels is that a connected component detection is not performed. All bits of the register of the internal storage medium are 0, indicating that the state information of all pixels stored in the second-type address blocks 1-4 is that a connected component detection is not performed.

As shown in FIG. 1C, it is assumed that the gray pixel region (such as the region composed of pixel 11, pixel 12, and pixel 22) is a connected component. In order to detect the connected component, the following operations can be performed.

Image data block 1 is read from first-type address block 1, and the state information corresponding to image data block 1 is read from the register of the external storage medium, such as bits 1-24 of the register of the external storage medium. Then, image data block 1 is stored in second-type address block 1, and the read state information is stored in bits 1-24 of the register of the internal storage medium. That is, bits 1-24 are all 0.

An example of a register of an internal storage medium is shown in Table 2. Bits 1-24 are the state information of the image data block in second-type address block 1, bits 25-48 of the register are the state information of the image data block in second-type address block 2, bits 49-72 of the register are the state information of the image data block in second-type address block 3, and bits 73-96 of the register are the state information of the image data block in second-type address block 4. In the initial state, these 96 bits are all empty (no value). After recording the 24 bits corresponding to image data block 1 to the register, as shown in Table 2, bits 1-24 are 0.

TABLE 2
000000000000000000000000

When pixel 11 is selected, pixel 12 is a pixel that meets the requirements and pixel 21 is not a pixel that meets the requirements. Therefore, the state information of pixel 11 and pixel 12 is modified to that the connected component detection has been performed and the detection result is that the pixel is connected, and the state information of pixel 21 is modified to that the connected component detection has been performed and the detection result is that the pixel is not connected. That is, the first and second bits corresponding to pixel 11 are modified to 10, the 3rd and 4th bits corresponding to pixel 12 are modified to 10, and the 9th and 10th bits corresponding to pixel 21 are modified to 01. An example of the modified state information is shown in Table 3.

TABLE 3
101000000100000000000000

When pixel 12 is selected, the pixels (adjacent pixels) associated with pixel 12 are pixel 11, pixel 13, and pixel 22. By looking up the Table 3, it is determined that the state information corresponding to pixel 11 is 10 (that is, the connected component detection has been performed and the detection result is that the pixel is connected), pixel 11 is no longer determined, and pixel 12 and pixel 11 belong to the same connected component (it is only a preliminary determination, and ultimately it needs to determine whether they are really connected component based on some factors such as area). By looking up the Table 3, it is determined that the state information corresponding to pixel 13 is 00 (that is, the connected component detection is not performed), and whether pixel 13 and pixel 11 belong to the same connected component is detected. Since pixel 13 is not a pixel that meets the requirements, the state information of pixel 13 is that the connected component detection has been performed and the detection result is that the pixel is not connected. The fifth and sixth bits corresponding to pixel 13 are modified to 01. In addition, since pixel 22 is a pixel that meets the requirements, that is, the state information of pixel 22 is that the connected component detection has been performed and the detection result is that the pixel is connected, the 11th and 12th bits corresponding to pixel 22 are modified to 10. An example of the modified state information is shown in Table 4.

TABLE 4
101001000110000000000000

When pixel 22 is selected, the pixels associated with pixel 22 are pixel 12, pixel 21, pixel 23, and pixel 32. By looking up Table 4, it is determined that the state information corresponding to pixel 12 is 10, that is, the connected component detection has been performed and the detection result is the pixel is connected. It is also determined that the state information corresponding to pixel 21 is 01, that is, the connected component detection has been performed and the detection result is that the pixel is not connected. In addition, since the state information corresponding to pixel 23 is 00, the connected component detection can be performed on pixel 23 to determine that pixel 23 is a pixel that meets the requirements. Since the state information corresponding to pixel 32 is 00, the connected component detection can be performed on pixel 32 to determine that pixel 32 is a pixel that meets the requirements. Then, the 13th and 14th bits corresponding to pixel 23 can be modified to 10, and the 19th and 20th bits corresponding to pixel 32 can be modified to 10. An example of the modified state information is shown in Table 5.

TABLE 5
101001000110100000100000

Similarly, each time when the connected component detection is performed, the state information of the pixel can be queried. If the state information is 01 or 10, the connected component detection is no longer performed on the pixel. If the state information is 00, the connected component detection is performed on the pixel. After performing the connected component detection on the pixel, the state information of the pixel can also be updated according to the detection result, such as updating 00 to 01 or 10.

After detecting each pixel in image data block 1, the obtained state information is shown in Table 6. In addition, after reading image data block 2 from first-type address block 2, the 24 bits corresponding to image data block 2 can also be read from the register of the external storage medium, and the 24 bits corresponding to image data block 2 can be recorded to the register of the internal storage medium. As shown in Table 7, bits 25-48 are 0.

TABLE 6
101001010110101001100101

TABLE 7
101001010110101001100101000000000000000000000000

After detecting each pixel in image data block 2, the obtained state information is shown in Table 8. After reading image data block 4 from first-type address block 4, the 24 bits corresponding to image data block 4 are read from the register of the external storage medium, and the 24 bits corresponding to image data block 4 are recorded to the register of the internal storage medium. As shown in Table 9, bits 73-96 are 0.

TABLE 8
101001010110101001100101010101001010100101010100

TABLE 9
101001010110101001100101010101001010100101010100
000000000000000000000000

After detecting each pixel in image data block 4, the obtained state information is shown in Table 10. After reading image data block 7 from first-type address block 7, the 24 bits corresponding to image data block 7 are read from the register of the external storage medium, and the 24 bits corresponding to image data block 7 are recorded to the register of the internal storage medium. As shown in Table 11, bits 49-72 are 0.

TABLE 10
101001010110101001100101010101001010100101010100
011001000110010001100100

TABLE 11
101001010110101001100101010101001010100101010100
000000000000000000000000011001000110010001100100

After detecting each pixel in image data block 7, the obtained state information is shown in Table 12. After reading image data block 10 from first-type address block 10, the 24 bits corresponding to image data block 10 are read from the register of the external storage medium, and the 24 bits corresponding to image data block 10 are recorded to the register of the internal storage medium. Since these 24 bits are recorded to bits 25-48 of the register, and bits 25-48 already have the state information of image data block 2, the state information “010101001010100101010100” of bits 25-48 are updated to the register of the external storage medium, that is, bits 25-48 of the register of the external storage medium (which is the state information corresponding to image data block 2) is updated to “010101001010100101010100”. Then, bits 25-48 of the register of the internal storage medium are updated to twenty-four Os corresponding to image data block 10, which is shown in Table 13.

TABLE 12
101001010110101001100101010101001010100101010100
011001000110010001100100011001000110010001100100

TABLE 13
101001010110101001100101000000000000000000000000
011001000110010001100100011001000110010001100100

Similarly, the subsequent process of state information update is not repeated. It can be seen from the above embodiments that only the state information corresponding to the last 4 image data blocks is stored in the register of the internal storage medium, and the connected component detection of these 4 image data blocks can be performed based on the connected component detection result analyzed from the state information (such as 00, 01, 10, etc.). So that multiple calculations can be avoided, and the number of calculations can be reduced.

After the connected component detection is completed, the register of the internal storage medium has stored the state information of the last four image data blocks. Then, the state information of other image data blocks can be read from the register of the external storage medium and is analyzed for the connected component detection. For example, if the connected component detection has been sequentially performed on image data block 1, image data block 2, image data block 4, image data block 7, image data block 10, image data block 13, and image data block 16 and after the connected component detection is completed, the state information of image data block 7, image data block 10, image data block 13, and image data block 16 can be stored in the register of the internal storage medium. Therefore, the state information of image data block 1, image data block 2, and image data block 4 can be read from the register of the external storage medium, so that based on the state information of image data block 1, image data block 2, image data block 4, image data block 7, image data block 10, image data block 13, and image data block 16, the connected component detection is analyzed. The process is not repeated here.

After the connected component detection is completed, all the state information stored in the register of the internal storage medium can also be updated to the register of the external storage medium, and the update process is not repeated here.

A detection circuit is also provided according to the embodiments of the present disclosure and is configured to read image data blocks from a first-type address block of an external storage medium. Original image data is divided into a plurality of image data blocks and each image data block includes part of the row data of the original image data. Each row of data includes part of the column data of the original image data. The detection circuit is further configured to store the read image data block in a second-type address block of an internal storage medium, use the image data blocks stored in the second-type address blocks to perform a connected component detection. The first-type address block is an arbitrary address block of the external storage medium. The second-type address block is an arbitrary address block of the internal storage medium.

After the detection circuit uses the image data blocks stored in the second-type address block to perform the connected component detection, it is also configured to determine the image data block associated with the pixel while performing the connected component detection on the pixel in the image data block stored in the second-type address block, read the image data block from the first-type address block used to store the image data block, and store the read image data block to the second-type address block of the internal storage medium.

When determining the image data block associated with the pixel, the detection circuit is specifically configured to do the following operations. If the last column of data of the current image data block is detected, the image data block including the column of data next to the last column of data is determined as the image data block associated with the pixel. And/or, if the last row of data of the current image data block is detected, the image data block including the row of data next to the last row of data is determined as the image data block associated with the pixel.

When reading the image data block from the first-type address block used to store the image data block, the detection circuit is specifically configured to read the image data block from the first-type address block used to store the image data block after completing the connected component detection on the pixels in the current image data block.

When reading the image data block from the first-type address block of the external storage medium, the detection circuit is specifically configured to sequentially read M*N pixels from the starting address of the first-type address block of the external storage medium and form image data blocks out of the read data. M and N are both integers greater than or equal to 1. M is the number of rows of the image data block, and N is the number of columns of the image data block.

The detection circuit is further configured to divide the original image data into a plurality of image data blocks, divide the storage space of the external storage medium into a plurality of first-type address blocks corresponding to the plurality of image data blocks, and store each image data block to the first-type address block corresponding to the image data block.

When storing the read image data block in the second-type address block of the internal storage medium, the detection circuit is configured to determine a second-type address block corresponding to the first-type address block based on a mapping table and store the read image data block to the second-type address block corresponding to the first-type address block. The mapping table is used to record a mapping relationship between the first-type address block and the second-type address block.

When using the image data block stored in the second-type address block to perform the connected component detection, the detection circuit is configured to when performing the connected component detection on a first pixel of the image data block stored in the second-type address block, select a second pixel associated with the first pixel from the image data block and perform the connected component detection based on the state information of the second pixel if there is state information of the second pixel. The state information is used to indicate whether a connected component detection has been performed on the second pixel.

When performing the connected component detection according to the state information of the second pixel, the detection circuit is configured to if the state information is that the connected component detection has not been performed, detect whether the second pixel and the first pixel belong to the same connected component, and update the state information of the second pixel according to the detection result. If the state information is that the connected component detection has been performed and the detection result is that the pixel is not connected, it can be determined that the second pixel and the first pixel do not belong to the same connected component. If the state information is that the connected component detection has been detected and the detection result is that the pixel is connected, it can be determined that the second pixel and the first pixel belong to the same connected component.

After selecting the second pixel associated with the first pixel, the detection circuit is configure to detect whether the second pixel and the first pixel belong to the same connected component if there is no state information of the second pixel, and update the state information of the second pixel according to the detection result.

The detection circuit is further configured to when reading the image data block from the first-type address block of the external storage medium, read the state information corresponding to each pixel in the image data block from the external storage medium and store the read state information in a register of the internal storage medium.

After storing the read state information in the register of the internal storage medium, the detection circuit is further configured to after using the pixel of the image data block to perform the connected component detection, determine the state information corresponding to the pixel, update the state information corresponding to the pixel in the register, and then update all the state information in the register to the external storage medium.

The detection circuit includes an FPGA chip or an ASIC chip.

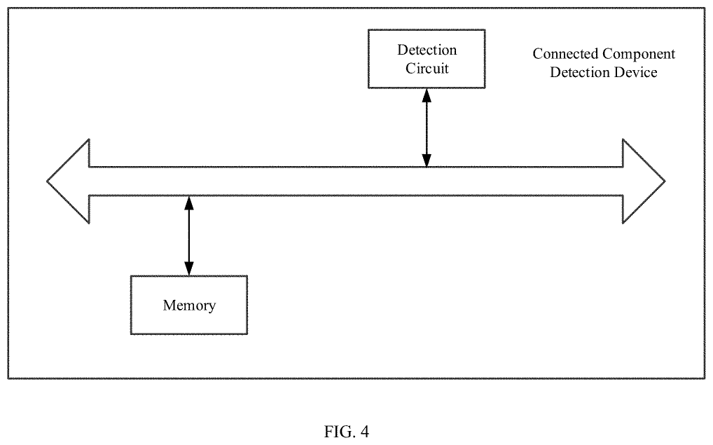

The present disclosure also provides a connected component detection device. As shown in FIG. 4, the connected component detection device includes a memory and a detection circuit (such as an FPGA chip or an ASIC chip). The memory is configured to store a program code and the detection circuit is configured to call the program code. When the program code is executed, the above connected component detection method is implemented.

The present disclosure further provides a computer-readable storage medium. The computer-readable storage medium stores a number of computer instructions, and when the computer instructions are executed, the above connected component detection method is implemented.

The system, device, module or unit explained in the above embodiments may be realized by a computer chip or entity, or by a product with a certain function. A typical implementation device is a computer, and the specific form of the computer may be a personal computer, a laptop computer, a cellular phone, a camera phone, a smart phone, a personal digital assistant, a media player, a navigation device, an email sending and receiving device, a game console, a tablet computer, a wearable device, or any combination of these devices.

For the convenience of description, the above devices are described separately with various units divided based on the functions. When implementing the present disclosure, the functions of each unit may be implemented with one or more software and/or hardware.

Those skilled in the art should understand that the embodiments of the present disclosure may be provided as methods, systems, or computer program products. Therefore, the present disclosure can be performed by hardware, software, or a combination thereof. Furthermore, the embodiments of the present disclosure may be provided as computer program products implemented on one or more computer-readable storage media (including but not limited to a magnetic disk, a CD-ROM, an optical disk, etc.) containing computer executable programs.

The present disclosure is described with reference to the flowcharts and/or block diagram of the method, the device (system), and the computer program according to the embodiments of the present disclosure. Each step and/or block in the flowchart and/or block diagram and a combination of the step and/or block in the flowchart and/or block diagram may be implemented by computer program instructions. These computer program instructions can be provided to a general-purpose computer, a special-purpose computer and an embedded processor, or other programmable data processing device to generate a machine. So that a device for realizing the functions specified in one step or multiple steps of the flowchart and/or one block or multiple blocks of the block diagram can be generated by using the processor of the computer or other programmable data processing device to perform the instructions.

Moreover, these computer program instructions may also be stored in a computer readable storage medium that can guide the computer or other programmable data processing device to work in a specific manner, so that a product including the instructions device can be generated with the instructions stored in the computer readable storage medium. The instruction device implements the functions specified in one step or multiple steps in the flowchart and/or one block or multiple blocks in the block diagram.

These computer program instructions can also be stored in a computer or other programmable data processing device, so that a series of operating steps are performed on the computer or other programmable device to generate a computer-implemented processing. Thereby executing instructions on the computer or other programmable device provides steps for implementing the functions specified in one step or multiple steps of the flowchart and/or one block or multiple blocks of the block diagram.

The above are only example embodiments of the present disclosure and are not intended to limit the present disclosure. For those skilled in the art, the present disclosure may have various modifications and changes. Any modification, equivalent replacement, and improvement made within the principle of the present disclosure shall be included in the scope of the present disclosure.

What is claimed is:

1. A connected component detection method comprising:
reading an image data block from an external address block of an external storage medium, the image data block being one of a plurality of image data blocks obtained by dividing original image data;
storing the read image data block in an internal address block of an internal storage medium; and
performing a connected component detection using the image data block stored in the internal address block.

2. The method of claim 1,
wherein the external address block is a first external address block, the internal address block is a first internal address block, and the image data block is a first image data block;
the method further comprising, after performing the connected using the first image data block stored in the first internal address block:
determining a second image data block associated with a pixel in the first image data block that is determined to be in a connected component;
reading the second image data block from a second external address block of the external storage medium that stores the second image data block; and
storing the second image data block into a second internal address block of the internal storage medium.

3. The method of claim 2, wherein determining the second image data block associated with the pixel includes at least one of:
in response to detecting that the pixel is in a last column of the first image data block, determining an image data block including a column of data next to the last column of the first image data block as the second image data block associated with the pixel; or
in response to detecting that the pixel is in a last row of the first image data block, determining an image data block including a row of data next to the last row of the first image data block as the second image data block associated with the pixel.

4. The method of claim 2, wherein reading the second image data block from the second external address block includes:
reading the second image data block from the second external address block after the connected component detection on the first image data block is completed.

5. The method of claim 1, wherein reading the image data block from the external address block of the external storage medium includes:
sequentially reading data of M*N pixels from a starting address of the external address block of the external storage medium, the data of the M*N pixels forming the image data block, where:
M and N are both integers greater than or equal to 1;
M is a number of rows of the image data block; and
N is a number of columns of the image data block.

6. The method of claim 5, wherein M is less than a total number of rows of the original image data, and N is less than a total number of columns of the original image data.

7. The method of claim 1, further comprising:
dividing the original image data into the plurality of image data blocks;
dividing a storage space of the external storage medium into a plurality of external address blocks corresponding to the plurality of image data blocks; and
storing each of the plurality of image data blocks to a corresponding one of the plurality of external address blocks.

8. The method of claim 7, wherein each of the plurality of image data blocks includes at most M rows of the original image data and at most N columns of the original image data, M and N being integers greater than or equal to 1.

9. The method of claim 1, wherein storing the read image data block in the internal address block of the internal storage medium includes:
determining the internal address block corresponding to the external address block based on a mapping table, the mapping table recording a mapping relationship between the external address block and the internal address block; and
storing the read image data block to the internal address block corresponding to the external address block.

10. The method of claim 1, further comprising:
obtaining a mapping relationship between the external address block and the internal address block; and
recording the mapping relationship between the external address block and the internal address block in a mapping table.

11. The method of claim 1, wherein:
the external address block is one of a plurality of external address blocks of the external storage medium;
the internal address block is one of one or more internal address blocks of the internal storage medium; and
a number of the plurality of external address blocks of the external storage medium is greater than a number of the one or more internal address blocks of the internal storage medium.

12. The method of claim 11, wherein each of the one or more internal address block corresponds to one or more of the plurality of external address blocks, and each of the plurality of external address blocks corresponds to one of the one or more internal address blocks.

13. The method of claim 1, wherein storing the read image data block to the internal address block includes, in response to an existing image data block being already stored in the internal address block:
deleting the existing image data block stored in the internal address block; and
storing the read image data block in the internal address block.

14. The method of claim 1, wherein performing the connected component detection using the image data block stored in the internal address block includes:
performing the connected component detection on a first pixel of the image data block stored in the internal address block, including selecting a second pixel associated with the first pixel from the image data block; and
in response to determining that state information of the second pixel exists, performing the connected component detection based on the state information of the second pixel, the state information indicating whether the connected component detection has been performed on the second pixel.

15. The method of claim 14, wherein performing the connected component detection according to the state information of the second pixel includes:
in response to the state information indicating that the connected component detection has not been performed on the second pixel, detecting whether the second pixel and the first pixel belong to a same connected component; and
updating the state information of the second pixel according to a detection result.

16. The method of claim 14, wherein performing the connected component detection according to the state information of the second pixel includes, in response to the state information indicating that the connected component detection has been performed on the second pixel and a detection result is that the second pixel is not connected to the first pixel, determining that the second pixel and the first pixel do not belong to a same connected component.

17. The method of claim 14, wherein performing the connected component detection according to the state information of the second pixel includes, in response to the state information indicating that the connected component detection has been performed on the second pixel and a detection result is that the second pixel is connected to the first pixel, determining that the second pixel and the first pixel belong to a same connected component.

18. The method of claim 14, further comprising, after selecting the second pixel associated with the first pixel:
in response to determining that no state information exists for the second pixel, detecting whether the second pixel and the first pixel belong to a same connected component; and
associating state information with the second pixel according to a detection result.

19. The method of claim 14, further comprising:
when reading the image data block from the external address block of the external storage medium, reading state information corresponding to each pixel in the image data block from the external storage medium; and
storing the read state information in a register of the internal storage medium.

20. A detection circuit configured to:
read an image data block from an external address block of an external storage medium, the image data block being one of a plurality of image data blocks obtained by dividing original image data;
store the read image data block in an internal address block of an internal storage medium; and
perform a connected component detection using the image data block stored in the internal address block.
